(19) United States
(12) Patent Application Publication
(10) Pub. No.: US 2021/0097587 A1
(43) Pub. Date: Apr. 1, 2021

(54) MANAGING SELF-DRIVING VEHICLES WITH PARKING SUPPORT

(71) Applicant: UATC, LLC, San Francisco, CA (US)

(72) Inventors: Shenglong Gao, San Francisco, CA (US); Mark Yen, San Francisco, CA (US)

(21) Appl. No.: 16/948,559

(22) Filed: Sep. 23, 2020

Related U.S. Application Data
(60) Provisional application No. 62/906,527, filed on Sep. 26, 2019.

(51) Int. Cl. G06Q 30/02; G06Q 20/32; G06Q 50/30; H04W 4/029; H04W 4/40; B60W 60/00

(52) U.S. Cl. CPC G06Q 30/0284; G06Q 20/325; G06Q 50/30; B60W 2556/45; H04W 4/40; B60W 60/0025; H04W 4/029

(57) ABSTRACT

Various examples are directed to systems and methods for operating a self-driving vehicle. A service arrangement system may select a first self-driving vehicle for providing a first transportation service. The service arrangement system may send to the first self-driving vehicle, first stopping location data describing a first set of stopping locations associated with the first transportation service. The service arrangement system may cause the first self-driving vehicle to begin executing a route associated with the first transportation service The service arrangement system may receive stopping location use data indicating that the first self-driving vehicle is stopped at a first stopping location of the first set of stopping locations and send stopping location payment data to a parking management system. The stopping location payment data may indicate a payment for use of the first stopping location by the first self-driving vehicle.

### CLAIM FOR PRIORITY

This application claims the benefit of priority of U.S. Application Ser. No. 62/906,527, filed Sep. 26, 2019, which is hereby incorporated by reference in its entirety.

### FIELD

This document pertains generally, but not by way of limitation, to devices, systems, and methods for operating and/or managing self-driving vehicles and, more particularly, to distributing transportation services to self-driving vehicles with parking support.

### BACKGROUND

A self-driving vehicle is a vehicle that is capable of sensing its environment and operating some or all of the vehicle's controls based on the sensed environment. A self-driving vehicle includes sensors that capture signals describing the environment surrounding the vehicle. The self-driving vehicle processes the captured sensor signals to comprehend the environment and automatically operates some or all of the vehicle's controls based on the resulting information.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for managing self-driving vehicles (SDVs) with parking support.

FIG. 2 depicts a block diagram of an example vehicle according to example aspects of the present disclosure.

FIG. 3 is a flowchart showing one example of a process flow that may be executed by the service arrangement system to manage SDVs with parking support.

FIG. 4 is a flowchart showing one example of a process flow that may be executed by the SDV upon being selected to execute a transportation service by the service arrangement system.

FIG. 5 is a flowchart showing one example of a process flow that can be executed by a vehicle autonomy system of the SDV to implement a route for an SDV.

FIG. 6 is a flowchart showing one example of a process flow that may be executed by the SDV upon being selected to execute a transportation service by the service arrangement system in which the SDV captures an indicator of a stopping location.

FIG. 7 is a block diagram showing one example of a software architecture for a computing device.

FIG. 8 is a block diagram illustrating a computing device hardware architecture, within which a set or sequence of instructions can be executed to cause a machine to perform examples of any one of the methodologies discussed herein.

### DESCRIPTION

Examples described herein are directed to systems and methods for managing SDVs with parking support. In various examples, SDVs are used, either alone or in conjunction with human-driven vehicles, to provide transportation services to users. A transportation service is a service that involves transporting people and/or cargo from a service start point to a service end point. In some examples, a transportation service includes picking up a human passenger, transporting the human passenger, and dropping the human passenger off at a desired location. In other examples, a transportation service includes picking up cargo, such as food, and packages, transporting the cargo, and dropping the cargo off at a desired location.

Various examples described herein utilize a service arrangement system to manage a fleet of self-driving vehicles, including self-driving vehicles of different types having different capabilities. The service arrangement system receives transportation service requests from users. When the service arrangement system receives a transportation service request, it selects a vehicle (such as an SDV) to execute the transportation service and offers the transportation service to the selected SDV. The selected SDV can accept the transportation service and begin to execute it.

To execute a transportation service, the SDV uses an on-board vehicle autonomy system to provide inputs to vehicle controls that tend to move the SDV along a route for the transportation service. In an autonomous or semi-autonomous SDV (collectively referred to as an SDV), the vehicle autonomy system, sometimes referred to as an SDV stack, controls one or more of braking, steering, or throttle of the vehicle. In a fully-autonomous SDV, the vehicle autonomy system assumes full control of the vehicle. In a semi-autonomous SDV, the vehicle autonomy system assumes a portion of the vehicle control, with a human user (e.g., a vehicle operator) still providing some control input. Some SDVs can also operate in a manual mode, in which a human user provides all control inputs to the vehicle.

Executing a transportation service can involve finding and/or parking an SDV at one or more stopping locations. A stopping location is a place where an SDV can stop, for example, off of a roadway or otherwise of the path of traffic. An SDV can use a stopping location to pick up or drop off a passenger, cargo, or other payload. For example, a stopping location can be a place where the SDV parks to pick up an item or items for delivery or a place where the SDV stops to make a delivery of an item or items to a customer. An SDV can also use a stopping location, in some examples, to remain stationary while awaiting a next transportation service assignment from the service arrangement system. Non-limiting examples of stopping locations include parking spots, driveways, roadway shoulders, and loading docks. A stopping location can also be referred to as a pick-up/drop-off zone (PDZ).

A stopping location can be available for stopping or unavailable for stopping. A stopping location is available for stopping if there is space at the stopping location for a vehicle, such as an SDV, to stop. For example, a single-vehicle parking spot is available for stopping if no other vehicle is present. A roadway shoulder location is available for stopping if there is an unoccupied portion of the roadway shoulder that is large enough to accommodate the SDV. In many applications, an SDV does not know if a particular stopping location is available until the stopping location is within the range of the SDV's sensors. If a first stopping location is unavailable, the SDV can wait until the first stopping location is available or, for example, move on to a next stopping location associated with a service end point or waypoint. If all stopping locations associated with an end point or waypoint are unavailable, the vehicle autonomy system and/or service arrangement system may generate a new route that passes additional stopping locations and/or re-passes previously-unavailable stopping locations.

The selection and use of stopping locations can present a particular challenge for SDVs, for example, in urban areas and other locations were parking is controlled by private and/or government entities. This is at least in part because of the variety of controls and fees associated with parking spots and other stopping locations. For example, a stopping location at a private parking lot may be accessible during a given set of business hours with a parking fee payable at a ticketing device at the lot. A stopping location at a municipal or other government owned parking spot may require payment if used during specified hours and to a meter positioned at the stopping location.

An SDV is less well-equipped to select and provide payment for stopping locations than a human-drive vehicle. For example, a human driver is able to get out of his or her car to provide coins to a parking meter or a ticket and credit card to a ticket machine. A human driver may also be more readily able to load a new parking app to a mobile phone or other mobile computing device for providing payment on an automated system.

Further, the problems associated with SDV parking can become more difficult when the service arrangement system is used to assign transportation services to different sets of SDVs, for example, having different capabilities and/or provided by different owners and/or different manufacturers. For example, different stopping locations may be accessed by applying different SDV capabilities. A stopping location at a street-side parking spot may be accessible to SDVs that are capable of parallel parking. A stopping location that is entered or exited by backing in or out may be accessible to SDVs that are capable of backing in and/or out.

Various examples address these and other problems by providing a transportation service environment that includes novel arrangements for selecting and providing payment for stopping locations used by SDVs to facilitate the provision of transportation services. A service arrangement system receives a transportation service request from a user and selects an SDV to execute the transportation service. The service arrangement system sends a service execution request to the selected SDV. The service execution request includes a description of the transportation service including, for example, a service start point and a service end point. In some examples, the service execution request also includes a route to be traversed to execute the transportation service. If the transportation service includes any waypoints, these may also be described by the service execution request.

The service execution request also includes stopping location data describing a set of stopping locations associated with the transportation service. Stopping locations included in the set of stopping locations can be selected by the service arrangement system in view of the transportation service, the SDV, and parking management support. For example, the set of stopping locations can include a sub-set of stopping locations associated with a service start point and a sub-set of stopping locations associated with a service end point. If the transportation service includes one or more service waypoints, the set of stopping locations can also include one or more additional sub-sets of stopping locations associated with the respective service waypoints. The service arrangement system may select the set of stopping locations based on the capabilities of the selected SDV. For example, the selected stopping locations may be limited to stopping locations that the selected SDV can enter and exit.

The stopping locations selected by the service arrangement system may also support payments initiated, for example, by the service arrangement system. For example, the stopping locations may be associated with a parking management system that accepts payment for use of a stopping location.

The SDV receives the service execution request, including the stopping location data, and in response begins executing the transportation service. When the SDV reaches a service start point, service end point, and/or service waypoint, the SDV selects a stopping location that is available for stopping (e.g., from the set of stopping locations) and stops at the stopping location. The SDV also sends to the service arrangement system stopping location data indicating that the vehicle is stopped at the stopping location. The stopping location data can include, for example, an image captured of the stopping location, geolocation data indicating the SDVs current position, handshake data describing a short-range communication medium handshake between the SDV and a parking management device at the parking spot, such as a meter.

In some examples, the stopping location data is provided to the service arrangement system from a parking management system or parking management device in addition to or instead of from the SDV. For example, a stopping location may be at a parking spot in a parking garage. The parking garage may include a camera or other image sensor that captures an image of the SDV (e.g., a license plate thereof) when the SDV enters and/or exits the stopping location. The parking management device and/or parking management system may provide the image, a timestamp of the image, and other information to the service arrangement system.

Responsive to the stopping location data, the service arrangement system sends stopping location payment data, for example, to the parking management system. The stopping location payment data can include, for example, a reference to a financial account and can describe a payment for use of the stopping location by the SDV.

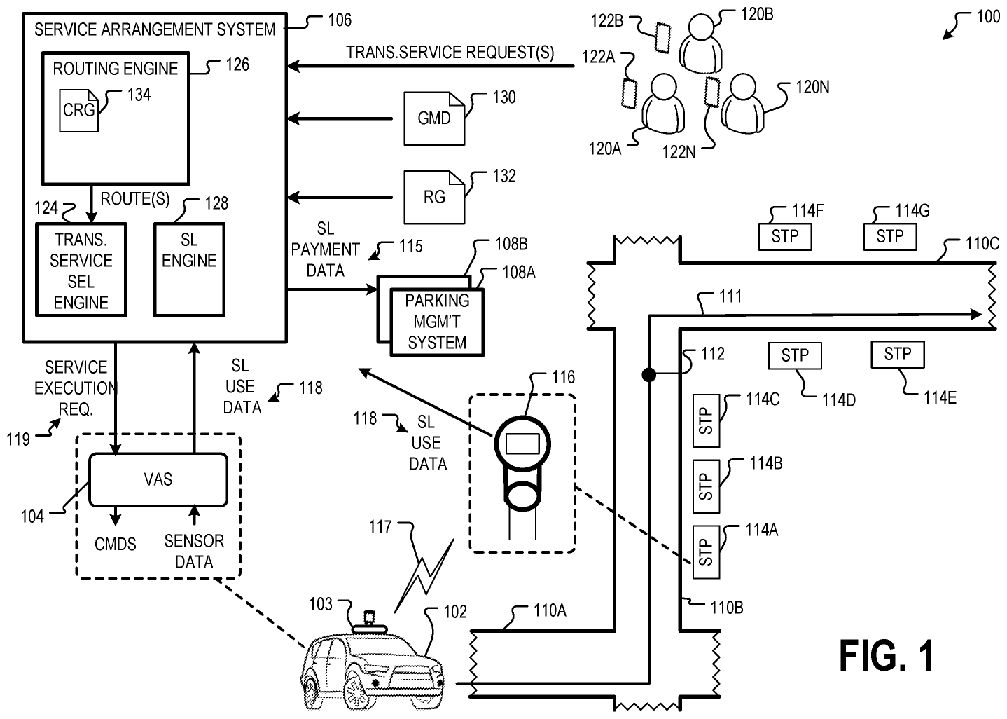

FIG. 1 is a diagram showing one example of an environment 100 for managing SDVs with parking support. The environment 100 shows an example SDV 102 executing a route 111 to execute a transportation service. The environment 100 also includes a service arrangement system 106, parking management system 108, and various other components for implementing transportation services with parking support.

In some examples, the SDV 102 is a passenger vehicle, such as a truck, a car, a bus or other similar vehicle. In other examples, the SDV 102 is a delivery vehicle, such as a van, a truck, a tractor trailer, etc. The SDV 102 includes a vehicle autonomy system that is configured to operate some or all the controls of the SDV 102 (e.g., acceleration, braking, steering). The vehicle autonomy system receives sensor data from the remote detection sensors 103 and generates commands that are provided to the controls of the SDV 102.

In some examples, the SDV 102 is operable in different modes where the vehicle autonomy system has differing levels of control over the SDV 102 in different modes. In a full autonomous mode, the vehicle autonomy system has responsibility for all or most of the controls of the SDV 102. In a semiautonomous mode, the vehicle autonomy system is responsible for some of the vehicle controls while a human user or driver is responsible for other vehicle controls. In some examples, the SDV 102 is operable in a manual mode in which the human user is responsible for all control of the SDV 102.

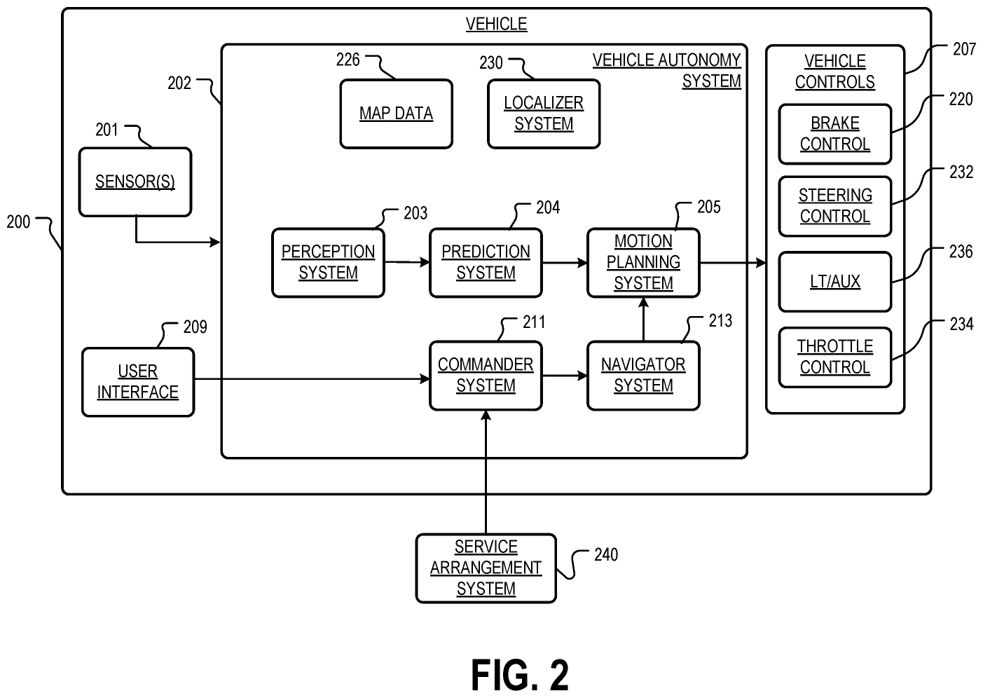

The SDV 102 include one or more remote detection sensors 103. Remote detection sensors 103 include one or more sensors that receive return signals from the environment 100. Return signals may be reflected from objects in the environment 100, such as the ground, buildings, trees, etc. The remote detection sensors 103 may include one or more active sensors, such as light imaging detection and ranging (LIDAR), radio detection and ranging (RADAR), and/or sound navigation and ranging (SONAR) that emit sound or electromagnetic radiation in the form of light or radio waves to generate return signals. Information about the environment 100 is extracted from the return signals. In some examples, the remote detection sensors 103 include one or more passive sensors that receive return signals that originated from other sources of sound or electromagnetic radiation. Remote detection sensors 103 provide remote-detection sensor data that describes the environment 100. The SDV 102 can also include other types of sensors, for example, as described in more detail with respect to FIG. 2.

The service arrangement system 106 is programmed to assign transportation services to the SDVs, including the SDV 102, as described herein. The service arrangement system 106 can be or include one or more servers or other suitable computing devices. The service arrangement system 106 is configured to receive transportation service requests from one or more users 120A, 120B, 120N. Users 120A, 120B, 120N can make transportation service requests with respective user computing devices 120A, 120B, 120N. The user computing devices 120A, 120B, 120N can be or include any suitable computing device such as, for example, tablet computers, mobile telephone devices, laptop computers, desktop computers, etc. In some examples, user computing devices 120A, 120B, 120N execute an application associated with a transportation service implemented with the service arrangement system 106. The users 120A, 120B, 120N launch the application on the respective computing devices 120A, 120B, 120N and utilize functionality of the application to make transportation service requests.

The service arrangement system 106 comprises a transportation service selection engine 124 that is programmed to receive and process transportation service requests and a routing engine 126 that generates routes for the candidate SDV 102 to execute a requested transportation service. When the transportation service selection engine 124 receives a transportation service request, it identifies a set of candidate SDVs for executing the transportation service, which may include the SDV 102. The set of candidate SDVs can include SDVs that are best suited for executing the transportation service. For example, the set of candidate SDVs can include SDVs that are near to a service start point. In some examples, the set of candidate SDVs are limited to vehicles capable of executing the transportation service. For example, a transportation service that involves moving a large object may be executable only by SDVs having sufficient space to carry the large object.

The transportation service selection engine 124 provides an indication of the set of candidate SDVs to the routing engine 126. The routing engine 126 generates candidate routes for some or all of the set of candidate SDVs. The candidate routes are described by respective route costs. The transportation service selection engine 124 uses the candidate routes to select the candidate SDV best suited to execute the route. For example, the candidate SDV best suited to execute the route may be the candidate SDV having the lowest cost route for the transportation service.

In this example, the transportation service selection engine 124 selects the SDV 102 for a transportation service. The service arrangement system 106 sends a transportation service execution request 119 to the SDV 102. In some examples, the SDV 102 can accept or decline the transportation service. In this example, the self-driving vehicle accepts the transportation service and begins to traverse towards the service start point to execute the transportation service.

The routing engine 126 generates routes utilizing, for example, a routing graph 132 in conjunction with graph modification data 130 such as, for example, vehicle capability data, policy data, operational graph modification data, etc. The routing graph 132 is a representation of the roadways in a geographic area. The routing graph 132 represents roadways as a set of graph elements. A graph element, sometimes also referred to as a lane segment, is a component of a routing graph that corresponds to portion of a roadway. In some examples, the routing graph 132 indicates directionality, connectivity, and cost for the various routing graph elements making up the roadways. Directionality indicates the direction of travel in a routing graph element. Connectivity describes possible transitions between routing graph elements. Cost describes the cost for the SDV 102 to traverse a routing graph element.

The routing engine 126 is configured to utilize graph modification data 130 to generate a constrained routing graph 134. Graph modification data 130 describes changes made to the routing graph, for example, based on policy and/or operational considerations. Generally, a graph modification includes a graph element property or set of graph element properties and one or more constraints. The graph element property or properties describe one or more routing graph elements that are subject to modification. The one or more constraints describe modifications to be made to routing graph elements having the set of routing graph element properties. Example constraints include removing routing graph elements having the indicated property or properties from the routing graph and removing connections to routing graph elements having the indicated property or properties from the routing graph. Other example constraints can include changing a cost associated with routing graph element and/or transitions to the routing graph element and/or changing the allowable mode that the SDV 102 is permitted to traverse the graph element.

Costs may be changed up or down. For example, if graph modification data 130 indicates that routing graph elements having a particular property or set of properties are disfavored, the costs to traverse and/or transition to the routing graph elements can be increased. On the other hand, if graph modification data 130 indicates that routing graph elements having a particular property or set of properties are favored, the costs to traverse and/or transition to the routing graph elements can be decreased.

Constraints can relate to routing graph elements that have the indicated modification property or properties. For example, if a policy forbids routing a vehicle through routing graph elements that include or are in a school zone, a corresponding constraint includes removing such school zone routing graph elements from the routing graph 132 and/or removing transitions to such school zone routing graph elements. Constraints can, in some examples, describe changes to routing graph elements other than those having the identified properties. Consider an example constraint that is to avoid cul-de-sacs. The associated constraint could involve removing routing graph elements that include cul-de-sacs and also removing routing graph elements that do not include cul-de-sacs but can lead only to other routing graph elements that include cul-de-sacs.

Some graph modifications are based on the capability of the SDV 102 to be routed. Vehicle capability data describes constraints associated with various SDV 102 of different types. For example, the vehicle capability data can be and/or be derived from Operational Domain (OD) or operational domain data (ODD), if any, provided by the vehicle's manufacturer. Routing graph modifications described by vehicle capability data can include data identifying a routing graph element property or properties (e.g., includes an unprotected left, is part of a controlled access highway) and constraint data indicating what is to be done to routing graph elements having the indicated property or properties. For example, routing graph elements that a particular vehicle type is not capable of traversing can be removed from the routing graph or can have connectivity data modified to remove transitions to those routing graph elements. For example, the service arrangement system 106 can remove one or more connections to the routing graph element. If the routing graph element properties indicate a maneuver that is undesirable for a vehicle, but not forbidden, then the constraint data can call for increasing the cost of an identified routing graph element or transitions thereto.

In some examples, the graph modification data 130 can also describe other modifications made to generate the constrained routing graph 134. For example, some modifications are based on policy. An example policy-based modification is to avoid routing graph elements that are in or pass through school zones. Another example policy-based modification is to avoid routing vehicles in residential neighborhoods. Yet another example policy-based modification is to favor routing vehicles on controlled-access highways, if available. Policy-based modification can apply to some vehicles, some vehicle types, all vehicles, or all vehicle types.

In some examples, the graph modification data 130 also describes operational modification. An operational modification can be based, for example, on the state of one or more roadways. For example, if a roadway is to be closed for a parade or for construction, an operational constraint identifies properties (e.g., names or locations) of routing graph elements that are part of the closure and an associated constraint (e.g., removing the routing graph elements, removing transitions to the routing graph elements).

The routing engine 126 utilizes the constrained routing graph 134 to generate a route for the SDV 102. (In some examples, different constrained routing graphs 134 are generated for different types of SDVs.) The routing engine 126 determines a route for the SDV 102, for example, by applying a path planning algorithm to the constrained routing graph 134 to find the lowest cost route for the vehicle. Any suitable path planning algorithm can be used, such as, for example, A*, D*, Focused D*, D* Lite, GD*, or Dijkstra's algorithm. A generated route can include a string of connected routing graph elements between a vehicle start point and a vehicle end point. A vehicle start point is an initial routing graph element of a route. A vehicle end point is a last routing graph element of a route. In some examples, the vehicle start point is a current location of the relevant SDV 102 and the vehicle end point is the service end point for the requested transportation service. For example, on the route, the SDV 102 can travel from its current location, to the service start point, and then proceed to the service end point traversing transportation service waypoints (if any) along the way.

The service arrangement system 106 also includes a stopping location engine 128. The stopping location engine 128 supports stopping location selection and payment for an SDV, such as the SDV 102, executing a transportation service. The stopping location engine 128 may be in communication with one or more parking management systems 108A, 108B and/or parking management devices 116.

A parking management system 108A, 108B comprises one or more computing devices that are programmed to manage a set of stopping locations. (In some examples, a parking management system 108A, 108B manages parking spots that can be used as stopping locations for SDVs and/or by human-driven vehicles). The parking management systems 108A, 108B are programmed to accept payment for the use of their managed parking spots. In some examples, parking management systems 108A, 108B provide additional services such as, for example, stopping location reservations, pre-payment, etc. In some examples, a parking management system 108A, 108B exposes an application programming interface (API) or other suitable electronic communication that allows other computing devices, such as the service arrangement system 106 (e.g., the stopping location engine 128) to access functionalities provided by the parking management systems 108A, 108B such as stopping location payment, reservation, etc. In some examples, a parking management device 116 at a stopping location provides an API to permit another computing device, such as the service arrangement system 106 (e.g., the stopping location engine 128 thereof).

The stopping location engine 128 accesses data describing stopping locations managed by one or more parking management systems 108A, 108B and/or parking management devices 116. The data can describe the stopping locations including, for example limitations on the use of the stopping locations (e.g., whether parallel parking is needed to use the stopping locations, stopping location sizes). When the transportation service engine 124 selects an SDV to execute a transportation service, the stopping location engine 128 may select a set of stopping locations associated with the transportation service. The set of stopping locations can include a sub-set of stopping locations associated with a service start point, a sub-set of stopping locations associated with a service end point and, optionally, one or more sub-sets of stopping locations associated with waypoints on the transportation service (if any). Stopping locations associated with a service start point, service end point, and/or waypoint may be near to the respective service start point, end point, or waypoint.

The stopping location engine 128, in some examples, selects the set of stopping locations to include stopping locations that are managed by a parking management system 108A, 108B and/or parking management device 116. This may allow the stopping location engine 128 to make an electronic payment to the relevant parking management system 108A, 108B, and/or parking management device 116, as described herein. The stopping location engine 128 may also select the set of stopping locations to include stopping locations that are accessible by the SDV 102 that is selected to execute the transportation service. For example, if the selected SDV 102 is not capable of parallel parking, the stopping location engine 128 may select stopping locations that do not require parallel parking. Stopping location data describing the set of stopping locations selected by the stopping location engine 128 is included in the service execution request 119 provided to the SDV 102.

In some examples, the SDV 102 may accept or decline the transportation service upon receiving the service execution request 119. In the example of FIG. 1, the SDV 102 accepts the transportation service. And begins traversing the route 111 for executing the transportation service. The portion of the route 111 that is shown in FIG. 1 includes a service start point 112 where the SDV 102 stops, for example, to pick up passengers and/or other cargo.

The service start point 112 is associated with stopping locations 114A, 114B, 114C, 114D, 114E, 114F, 114G, which are part of the sub-set of stopping locations associated with the service stop point. In the example of FIG. 1, the service start point is at or near a city block and the stopping locations 114A, 114B, 114C, 114D, 114E, 114F, 114G may include shoulders or curb-side areas on the city block where the SDV 102 can pull-over. The stopping locations 114A, 114B, 114C, 114D, 114E, 114F, 114G associated with the service start point 112 can be stopping locations that are within a threshold distance of the service start point 112. In some examples, the stopping locations 114A, 114B, 114C, 114D, 114E, 114F, 114G associated with the service start point 112 are provided by the service arrangement system 106 as part of a service execution request, as described in more detail herein.

The vehicle autonomy system 104 directs the SDV 102 along the route portion 111 and past the stopping locations 114A, 114B, 114C, 114D, 114E, 114F, 114G. If the SDV 102 approaches one of the stopping locations 114A, 114B, 114C, 114D, 114E, 114F, 114G and determines that the stopping location 114A, 114B, 114C, 114D, 114E, 114F, 114G is available for stopping, the SDV 102 stops the SDV 102 at the available stopping location 114A, 114B, 114C, 114D, 114E, 114F, 114G. Although a service start location 112 and its associated stopping locations 114A, 114B, 114C, 114D, 114E, 114F, 114G are shown in FIG. 1, similar arrangements of stopping locations may be used by service end points and/or waypoints.

When the SDV 102 stops at a stopping location, 114A, 114B, 114C, 114D, 114E, 114F, 114G, it is configured to collect stopping location use data 118 and provide the stopping location use data 118 to the service arrangement system 106 (e.g., the stopping location engine 128 thereof). The stopping location use data 118 indicates the stopping location 114A, 114B, 114C, 114D, 114E, 114F, 114G used by the SDV 102.

In some examples, the SDV 102 gathers stopping location use data 118 and provides the stopping location use data 118 to the service arrangement system 106 in any suitable manner. The stopping location use data 118 can include geographic data indicating one or more geographic locations of the SDV 102. For example, when the SDV 102 enters and/or exits a stopping location 114A, 114B, 114C, 114D, 114E, 114F, 114G, the SDV 102 may determine its geographic location and provide the geolocation data describing the geographic location (and optionally a timestamp) as stopping location use data. The SDV 102 can gather the geolocation data, for example, utilizing a global positioning system (GPS) sensor, or other suitable sensor or system. In some examples, the SDV 102 determines its geographic position using a localizer system, described in more detail herein with respect to FIG. 2. The stopping location engine 128 or other suitable component of the service arrangement system 106 matches the geographic position of the SDV 102 with the known geographic position of a stopping location (e.g., from the set of stopping locations provided to the SDV 102).

The SDV 102 can provide stopping location use data including geographic location data in real time or batch arrangement. In a real-time arrangement, the SDV 102 provides geographic location data to the service arrangement system 106 at or about the time that the SDV 102 enters and/or exits the stopping location 114A, 114B, 114C, 114D, 114E, 114F, 114G. In a batch arrangement, the SDV 102 provides geographic location data over a period, such as the period of time during which a transportation service is executed. The stopping location engine 128 analyzes the location data to determine stopping locations where the SDV 102 stopped during the period of time. In some examples, the stopping location engine 128 also determines the length of time that the SDV 102 occupied the stopping location 114A, 114B, 114C, 114D, 114E, 114F, 114G, for example, from one or more timestamps associated with the geographic location data.

In some examples, the SDV 102 captures the stopping location use data 118 indicative of the stopping location using a sensor, such as a remote detection sensor. For example, some or all of the stopping locations 114A, 114B, 114C, 114D, 114E, 114F, 114G may have unique physical indicia. The physical indicia can include, for example, an alphanumeric code, a bar code, a QR code, etc. The SDV 102 may use a camera or other image sensor to capture image data depicting the physical indicia. The image data may be provided to the service arrangement system 106 with the stopping location use data.

In some examples, the SDV 102 captures stopping location use data by performing a handshake routine with a parking management device 116 at a stopping location, for example, using a short range communications medium 117. The short range communication medium 117 is a wireless medium that enables communication between devices that are near to one another (e.g., devices within about 10 meters of one another, devices with a line-of-sight path there between, etc.) For example, the short range communication medium 117 may include, near field communication (NFC), Bluetooth®, Bluetooth LE™, an infrared connection, etc. According to a handshake routine, the SDV 102 and parking management device 116 exchange messages with one another via the short range communications medium 117. The messages can include, for example, implementing any suitable authentication routine. As a result of the handshake routine, the SDV 102 receives handshake data uniquely identifying the parking management device 116 and/or the stopping location 114A, 114B, 114C, 114D, 114E, 114F, 114G where the SDV 102 is stopped. The handshake data indicating the parking management device 116 and/or stopping location 114A, 114B, 114C, 114D, 114E, 114F, 114G is provided to the service arrangement system 106 as stopping location use data. In some examples, the stopping location use data 118 gathered by a parking management device 116 may include short range communications handshake data received from the SDV 102 via the short range communications medium 117.

In another example, the parking management device 116 gathers the stopping location user data, for example, by providing an indication of the SDV 102 parked at a stopping location to the service arrangement system 106. Stopping location use data 118 gathered by the parking management device 116 can include, for example, image data depicting the SDV 102 (e.g., a license plate number, vehicle identification number (VIN), or other suitable identifier).

In some examples, the stopping location data 118 includes geolocation data captured by the SDV 102, for example, at the stopping location. The geolocation data can include, for example, GPS data.

Upon receiving the stopping location use data 118, the stopping location engine 128 sends stopping location payment data 115 to the parking management system 108A, 108B associated with one or more stopping locations used by the SDV 102. The stopping location payment data 115 can include, for example, an indication of one or more stopping locations used by the SDV 102 and, in some examples, an indication of the duration that the one or more stopping locations were used by the SDV 102.

In some examples, the stopping location engine 128 uses timestamps or other indications of time associated with stopping location use data to derive the time that the SDV 102 was stationary at a particular stopping location. For example, the SDV 102 may capture first geolocation data when it initially stops or become stationary at a stopping location and second geolocation data when it leaves the stopping location. A difference between the timestamps of the first geolocation data and the second geolocation data indicates the time that the SDV 102 was stationary at the stopping location. In another example, the SDV 102 can capture other examples of stopping location use data both when it enters a stopping location and when it exits the stopping location, allowing the duration of the stop to be determined from the respective time stamps. The length of time that the SDV 102 was stationary at a stopping location may affect the stopping location payment data 115. For example, longer times that the SDV 102 is stationary at a stopping location may correspond to higher payments.

FIG. 2 depicts a block diagram of an example vehicle 200 (e.g., the SDV 102) according to example aspects of the present disclosure. The vehicle 200 includes one or more sensors 201, a vehicle autonomy system 202, and one or more vehicle controls 207. The vehicle 200 is a self-driving vehicle, as described herein. The example vehicle 200 shows just one example arrangement of a self-driving vehicle. In some examples, SDVs of different types can have different arrangements.

The vehicle autonomy system 202 includes a commander system 211, a navigator system 213, a perception system 203, a prediction system 204, a motion planning system 205, and a localizer system 230 that cooperate to perceive the surrounding environment of the vehicle 200 and determine a motion plan for controlling the motion of the vehicle 200 accordingly.

The vehicle autonomy system 202 is engaged to control the vehicle 200 or to assist in controlling the vehicle 200. In particular, the vehicle autonomy system 202 receives sensor data from the one or more sensors 201, attempts to comprehend the environment surrounding the vehicle 200 by performing various processing techniques on data collected by the sensors 201, and generates an appropriate route through the environment. The vehicle autonomy system 202 sends commands to control the one or more vehicle controls 207 to operate the vehicle 200 according to the route.

Various portions of the vehicle autonomy system 202 receive sensor data from the one or more sensors 201. For example, the sensors 201 may include remote-detection sensors as well as motion sensors such as an inertial measurement unit (IMU), one or more encoders, or one or more odometers. The sensor data includes information that describes the location of objects within the surrounding environment of the vehicle 200, information that describes the motion of the vehicle 200, etc.

The sensors 201 may also include one or more remote-detection sensors or sensor systems, such as a LIDAR, a RADAR, one or more cameras, etc. As one example, a LIDAR system of the one or more sensors 201 generates sensor data (e.g., remote-detection sensor data) that includes the location (e.g., in three-dimensional space relative to the LIDAR system) of a number of points that correspond to objects that have reflected a ranging laser. For example, the LIDAR system measures distances by measuring the Time of Flight (TOF) that it takes a short laser pulse to travel from the sensor to an object and back, calculating the distance from the known speed of light.

As another example, a RADAR system of the one or more sensors 201 generates sensor data (e.g., remote-detection sensor data) that includes the location (e.g., in three-dimensional space relative to the RADAR system) of a number of points that correspond to objects that have reflected ranging radio waves. For example, radio waves (e.g., pulsed or continuous) transmitted by the RADAR system reflect off an object and return to a receiver of the RADAR system, giving information about the object's location and speed. Thus, a RADAR system provides useful information about the current speed of an object.

As yet another example, one or more cameras of the one or more sensors 201 may generate sensor data (e.g., remote-detection sensor data) including still or moving images. Various processing techniques (e.g., range imaging techniques such as structure from motion, structured light, stereo triangulation, and/or other techniques) can be performed to identify the location (e.g., in three-dimensional space relative to the one or more cameras) of a number of points that correspond to objects that are depicted in an image or images captured by the one or more cameras. Other sensor systems can identify the location of points that correspond to objects as well.

As another example, the one or more sensors 201 can include a positioning system. The positioning system determines a current position of the vehicle 200. The positioning system can be any device or circuitry for analyzing the position of the vehicle 200. For example, the positioning system can determine a position by using one or more of inertial sensors, a satellite positioning system such as a Global Positioning System (GPS), based on IP address, by using triangulation and/or proximity to network access points or other network components (e.g., cellular towers, WiFi access points) and/or other suitable techniques. The position of the vehicle 200 can be used by various systems of the vehicle autonomy system 202.

Thus, the one or more sensors 201 are used to collect sensor data that includes information that describes the location (e.g., in three-dimensional space relative to the vehicle 200) of points that correspond to objects within the surrounding environment of the vehicle 200. In some implementations, the sensors 201 can be positioned at various different locations on the vehicle 200.

As an example, in some implementations, one or more cameras and/or LIDAR sensors can be located in a pod or other structure that is mounted on a roof of the vehicle 200 while one or more RADAR sensors can be located in or behind the front and/or rear bumper(s) or body panel(s) of the vehicle 200. As another example, camera(s) can be located at the front or rear bumper(s) of the vehicle 200. Other locations can be used as well.

The localizer system 230 receives some or all of the sensor data from sensors 201 and generates vehicle poses for the vehicle 200. A vehicle pose describes a position and attitude of the vehicle 200. The vehicle pose (or portions thereof) can be used by various other components of the vehicle autonomy system 202 including, for example, the perception system 203, the prediction system 204, the motion planning system 205 and the navigator system 213.

The position of the vehicle 200 is a point in a three-dimensional space. In some examples, the position is described by values for a set of Cartesian coordinates, although any other suitable coordinate system may be used. The attitude of the vehicle 200 generally describes the way in which the vehicle 200 is oriented at its position. In some examples, attitude is described by a yaw about the vertical axis, a pitch about a first horizontal axis, and a roll about a second horizontal axis. In some examples, the localizer system 230 generates vehicle poses periodically (e.g., every second, every half second). The localizer system 230 appends time stamps to vehicle poses, where the time stamp for a pose indicates the point in time that is described by the pose. The localizer system 230 generates vehicle poses by comparing sensor data (e.g., remote-detection sensor data) to map data 226 describing the surrounding environment of the vehicle 200.

In some examples, the localizer system 230 includes one or more pose estimators and a pose filter. Pose estimators generate pose estimates by comparing remote-sensor data (e.g., LIDAR, RADAR) to map data. The pose filter receives pose estimates from the one or more pose estimators as well as other sensor data such as, for example, motion sensor data from an IMU, encoder, or odometer. In some examples, the pose filter executes a Kalman filter or machine learning algorithm to combine pose estimates from the one or more pose estimators with motion sensor data to generate vehicle poses. In some examples, pose estimators generate pose estimates at a frequency less than the frequency at which the localizer system 230 generates vehicle poses. Accordingly, the pose filter generates some vehicle poses by extrapolating from a previous pose estimate utilizing motion sensor data.

Vehicle poses and/or vehicle positions generated by the localizer system 230 are provided to various other components of the vehicle autonomy system 202. For example, the commander system 211 may utilize a vehicle position to determine whether to respond to a call from a service arrangement system 240.

The commander system 211 determines a set of one or more target locations that are used for routing the vehicle 200. The target locations are determined based on user input received via a user interface 209 of the vehicle 200. The user interface 209 may include and/or use any suitable input/output device or devices. In some examples, the commander system 211 determines the one or more target locations considering data received from the service arrangement system 240. The service arrangement system 240 is programmed to provide instructions to multiple vehicles, for example, as part of a fleet of vehicles for moving passengers and/or cargo. Data from the service arrangement system 240 can be provided via a wireless network, for example.

The navigator system 213 receives one or more target locations from the commander system 211 and map data 226. Map data 226, for example, provides detailed information about the surrounding environment of the vehicle 200. Map data 226 provides information regarding identity and location of different roadways and segments of roadways (e.g., lane segments or routing graph elements). A roadway is a place where the vehicle 200 can drive and may include, for example, a road, a street, a highway, a lane, a parking lot, or a driveway. Routing graph data is a type of map data 226.

From the one or more target locations and the map data 226, the navigator system 213 generates route data describing a route for the vehicle to take to arrive at the one or more target locations. In some implementations, the navigator system 213 determines route data using one or more path planning algorithms based on costs for routing graph elements, as described herein. For example, a cost for a route can indicate a time of travel, risk of danger, or other or other factor associated with adhering to a particular candidate route. For example, the reward can be of a sign opposite to that of cost. Route data describing a route is provided to the motion planning system 205, which commands the vehicle controls 207 to implement the route or route extension, as described herein. The navigator system 213 can generate routes as described herein using a general purpose routing graph and graph modification data. Also, in examples where route data is received from a service arrangement system, that route data can also be provided to the motion planning system 205.

The perception system 203 detects objects in the surrounding environment of the vehicle 200 based on sensor data, map data 226, and/or vehicle poses provided by the localizer system 230. For example, map data 226 used by the perception system describes roadways and segments thereof and may also describe: buildings or other items or objects (e.g., lampposts, crosswalks, curbing); location and directions of traffic lanes or lane segments (e.g., the location and direction of a parking lane, a turning lane, a bicycle lane, or other lanes within a particular roadway); traffic control data (e.g., the location and instructions of signage, traffic lights, or other traffic control devices); and/or any other map data that provides information that assists the vehicle autonomy system 202 in comprehending and perceiving its surrounding environment and its relationship thereto.

In some examples, the perception system 203 determines state data for one or more of the objects in the surrounding environment of the vehicle 200. State data describes a current state of an object (also referred to as features of the object). The state data for each object describes, for example, an estimate of the object's: current location (also referred to as position); current speed (also referred to as velocity); current acceleration; current heading; current orientation; size/shape/footprint (e.g., as represented by a bounding shape such as a bounding polygon or polyhedron); type/class (e.g., vehicle versus pedestrian versus bicycle versus other); yaw rate; distance from the vehicle 200; minimum path to interaction with the vehicle 200; minimum time duration to interaction with the vehicle 200; and/or other state information.

In some implementations, the perception system 203 determines state data for each object over a number of iterations. In particular, the perception system 203 updates the state data for each object at each iteration. Thus, the perception system 203 detects and tracks objects, such as other vehicles, that are proximate to the vehicle 200 over time.

The prediction system 204 is configured to predict one or more future positions for an object or objects in the environment surrounding the vehicle 200 (e.g., an object or objects detected by the perception system 203). The prediction system 204 generates prediction data associated with one or more of the objects detected by the perception system 203. In some examples, the prediction system 204 generates prediction data describing each of the respective objects detected by the prediction system 204.

Prediction data for an object is indicative of one or more predicted future locations of the object. For example, the prediction system 204 may predict where the object will be located within the next 5 seconds, 20 seconds, 200 seconds, etc. Prediction data for an object may indicate a predicted trajectory (e.g., predicted path) for the object within the surrounding environment of the vehicle 200. For example, the predicted trajectory (e.g., path) can indicate a path along which the respective object is predicted to travel over time (and/or the speed at which the object is predicted to travel along the predicted path). The prediction system 204 generates prediction data for an object, for example, based on state data generated by the perception system 203. In some examples, the prediction system 204 also considers one or more vehicle poses generated by the localizer system 230 and/or map data 226.

In some examples, the prediction system 204 uses state data indicative of an object type or classification to predict a trajectory for the object. As an example, the prediction system 204 can use state data provided by the perception system 203 to determine that a particular object (e.g., an object classified as a vehicle) approaching an intersection and maneuvering into a left-turn lane intends to turn left. In such a situation, the prediction system 204 predicts a trajectory (e.g., path) corresponding to a left-turn for the vehicle 200 such that the vehicle 200 turns left at the intersection. Similarly, the prediction system 204 determines predicted trajectories for other objects, such as bicycles, pedestrians, parked vehicles, etc. The prediction system 204 provides the predicted trajectories associated with the object(s) to the motion planning system 205.

In some implementations, the prediction system 204 is a goal-oriented prediction system 204 that generates one or more potential goals, selects one or more of the most likely potential goals, and develops one or more trajectories by which the object can achieve the one or more selected goals. For example, the prediction system 204 can include a scenario generation system that generates and/or scores the one or more goals for an object, and a scenario development system that determines the one or more trajectories by which the object can achieve the goals. In some implementations, the prediction system 204 can include a machine-learned goal-scoring model, a machine-learned trajectory development model, and/or other machine-learned models.

The motion planning system 205 commands the vehicle controls based at least in part on the predicted trajectories associated with the objects within the surrounding environment of the vehicle 200, the state data for the objects provided by the perception system 203, vehicle poses provided by the localizer system 230, map data 226, and route or route extension data provided by the navigator system 213. Stated differently, given information about the current locations of objects and/or predicted trajectories of objects within the surrounding environment of the vehicle 200, the motion planning system 205 determines control commands for the vehicle 200 that best navigate the vehicle 200 along the route or route extension relative to the objects at such locations and their predicted trajectories on acceptable roadways.

In some implementations, the motion planning system 205 can also evaluate one or more cost functions and/or one or more reward functions for each of one or more candidate control commands or sets of control commands for the vehicle 200. Thus, given information about the current locations and/or predicted future locations/trajectories of objects, the motion planning system 205 can determine a total cost (e.g., a sum of the cost(s) and/or reward(s) provided by the cost function(s) and/or reward function(s)) of adhering to a particular candidate control command or set of control commands. The motion planning system 205 can select or determine a control command or set of control commands for the vehicle 200 based at least in part on the cost function(s) and the reward function(s). For example, the motion plan that minimizes the total cost can be selected or otherwise determined.

In some implementations, the motion planning system 205 can be configured to iteratively update the route or route extension for the vehicle 200 as new sensor data is obtained from one or more sensors 201. For example, as new sensor data is obtained from one or more sensors 201, the sensor data can be analyzed by the perception system 203, the prediction system 204, and the motion planning system 205 to determine the motion plan.

The motion planning system 205 can provide control commands to one or more vehicle controls 207. For example, the one or more vehicle controls 207 can include throttle systems, brake systems, steering systems, and other control systems, each of which can include various vehicle controls (e.g., actuators or other devices that control gas flow, steering, braking) to control the motion of the vehicle 200. The various vehicle controls 207 can include one or more controllers, control devices, motors, and/or processors.

The vehicle controls 207 includes a brake control module 220. The brake control module 220 is configured to receive a braking command and bring about a response by applying (or not applying) the vehicle brakes. In some examples, the brake control module 220 includes a primary system and a secondary system. The primary system receives braking commands and, in response, brakes the vehicle 200. The secondary system may be configured to determine a failure of the primary system to brake the vehicle 200 in response to receiving the braking command.

A steering control system 232 is configured to receive a steering command and bring about a response in the steering mechanism of the vehicle 200. The steering command is provided to a steering system to provide a steering input to steer the vehicle 200.

A lighting/auxiliary control module 236 receives a lighting or auxiliary command. In response, the lighting/auxiliary control module 236 controls a lighting and/or auxiliary system of the vehicle 200. Controlling a lighting system may include, for example, turning on, turning off, or otherwise modulating headlines, parking lights, running lights, etc. Controlling an auxiliary system may include, for example, modulating windshield wipers, a defroster, etc.

A throttle control system 234 is configured to receive a throttle command and bring about a response in the engine speed or other throttle mechanism of the vehicle. For example, the throttle control system 234 can instruct an engine and/or engine controller, or other propulsion system component to control the engine or other propulsion system of the vehicle 200 to accelerate, decelerate, or remain at its current speed.

Each of the perception system 203, the prediction system 204, the motion planning system 205, the commander system 211, the navigator system 213, and the localizer system 230, can be included in or otherwise be a part of a vehicle autonomy system 202 configured to control the vehicle 200 based at least in part on data obtained from one or more sensors 201. For example, data obtained by one or more sensors 201 can be analyzed by each of the perception system 203, the prediction system 204, and the motion planning system 205 in a consecutive fashion in order to control the vehicle 200. While FIG. 2 depicts elements suitable for use in a vehicle autonomy system according to example aspects of the present disclosure, one of ordinary skill in the art will recognize that other vehicle autonomy systems can be configured to control a self-driving vehicle based on sensor data.

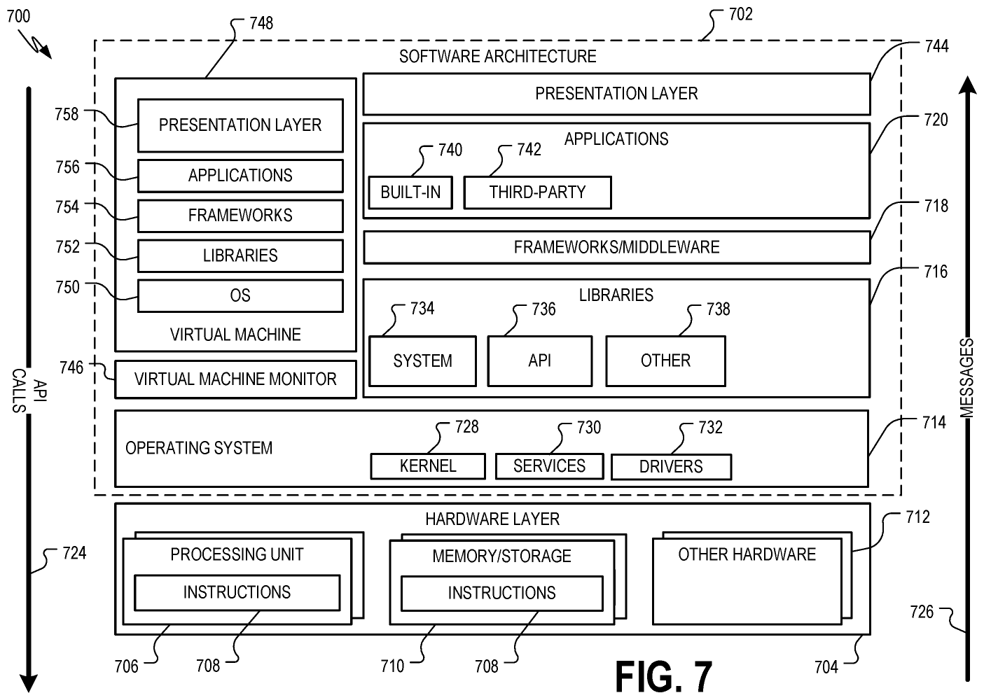

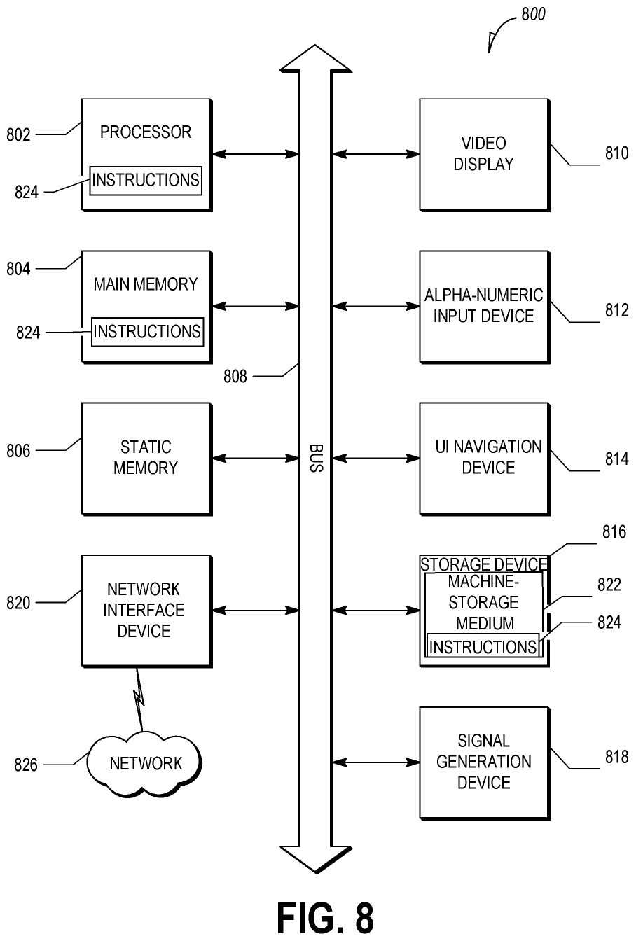

The vehicle autonomy system 202 includes one or more computing devices, which may implement all or parts of the perception system 203, the prediction system 204, the motion planning system 205 and/or the localizer system 230. Descriptions of hardware and software configurations for computing devices to implement the vehicle autonomy system 202 and/or the vehicle autonomy system 106 are provided herein at FIGS. 7 and 8.

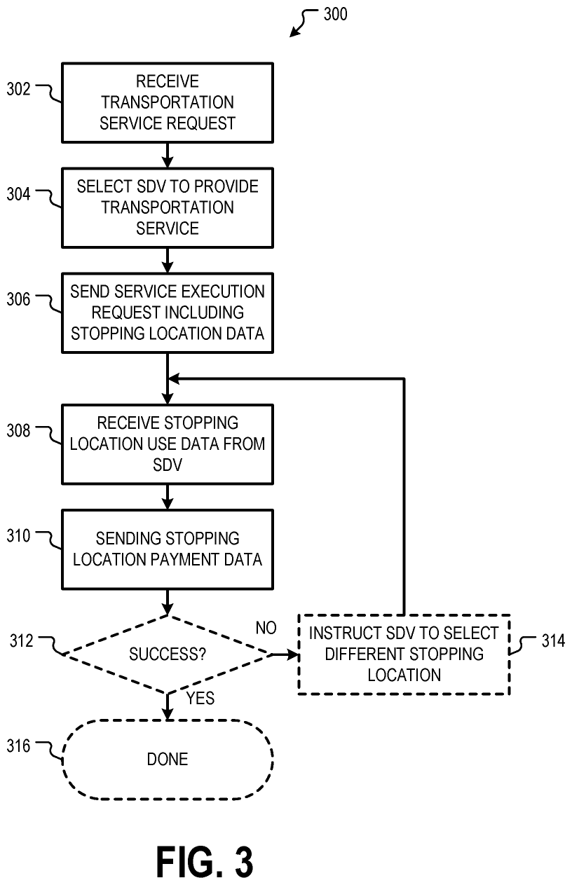

FIG. 3 is a flowchart showing one example of a process flow 300 that may be executed by the service arrangement system 106 to manage SDVs with parking support. At operation 302, the service arrangement system 106 receives a transportation service request from a user 120A, 120B, 120N, for example, via a user computing device 122A, 122B, 122N. The transportation service request describes a transportation service requested by the user 120A, 120B, 120N. For example, the transportation service request may indicate a service start point, a service end point and, optionally, one or more service waypoints. The transportation service request may also indicate a payload to be transported for the transportation service. For example, the transportation service request may indicate a number of passengers (if any), a number and type of cargo (if any), etc.

At operation 304, the service arrangement system 106 selects an SDV to execute the transportation service request, for example, as described herein with respect to FIG. 1. For example, the service arrangement system 106 may select a set of candidate SDVs that have the capability to carry the payload requested by the user 120A, 120B, 120N. In some examples, the service arrangement system 106 selects as candidate SDVs those SDVs that are near the service start point (e.g., within a threshold distance). The routing engine 126 may generate routes for the candidate SDVs to execute the transportation service. The transportation service selection engine 124 selects an SDV 102, for example, with the lowest cost route to execute the transportation service.

At operation 306, the service arrangement system sends to the selected SDV 102 a service execution request 119. The service execution request 119, as described herein, describes the transportation service including, for example, the service start point, the service end point, and service waypoints (if any). In some examples, the service execution request 119 also describes the payload for the service and/or the requesting user 120A, 120B, 120N. The service execution request 119 also includes stopping location data indicating a set of stopping locations. As described here, a first sub-set of the stopping location data includes stopping locations associated with the service start point. A second sub-set of the stopping location data includes stopping locations associated with the service end point. If there are waypoints for the service, there may be additional sub-sets of stopping locations associated with the service waypoints.

The service arrangement system 106 selects the stopping locations included in the set of stopping locations, for example, based on the capabilities of the SDV, as described herein. In another example, the service arrangement system selects the stopping locations included in the set of stopping locations to include stopping locations that are managed by at least one parking management system 108A, 108B or parking management device 116. In this way, the service arrangement system 106 may provide payment data for use of the stopping locations, as described herein.

At operation 308, the service arrangement system 106 receives stopping location use data 118. The stopping location use data 118 indicates at least one stopping location that is or was occupied by the SDV 102. Stopping location use data 118 can be received from the SDV 102, from the parking management system 108A, 108B, and/or from the parking management device 116.

The stopping location use data 118 can indicate a stopping location in any suitable manner. For example, the stopping location use data 118 can include geolocation data captured by the SDV 102 indicating a location of the SDV 102. The stopping location use data 118 can also include handshake data received by the SDV 102 from a parking management device 116 via a short range communication medium, and/or handshake data received by a parking management device 116 from the SDV 102. The stopping location use data 118 may also include image data, such as, for example, image data received from a parking management system 108A, 108B or device 116 showing the SDV 102 and/or from the SDV 102 showing an indication of a stopping locations.

At operation 310, the stopping location engine 128 sends stopping location payment data 115 to the parking management system 108A, 108B associated with the stopping location indicated by the stopping location use data 118. The stopping location payment data can include, for example, an indication of an account from which the parking management system 108A, 108B can deduct payment for use of the stopping location. This can include, for example, a credit card account number or other suitable credit card account indicator, etc.

At optional operation 312, the stopping location engine 128 determines if the transmission of the stopping location payment data was successful. For example, the transmission may fail for various reasons including, for example, network connectivity problems, data transmission glitches, a failure of an API implemented by a parking management device 116 or system 106A, 106B. If the transmission of the stopping location payment data 115 was successful, then the process flow 300 may conclude at optional operation 316. On the other hand, if the transmission of the stopping location payment data 115 is unsuccessful, the stopping location engine 128, at optional operation 314, may instruct the SDV 102 to move to a different stopping location (e.g., a different stopping location included with the stopping location data provided to the SDV 102 at operation 306). The SDV 102 may stop at a different stopping location and provide stopping location data to the stopping location engine 126, which is received at operation 306.

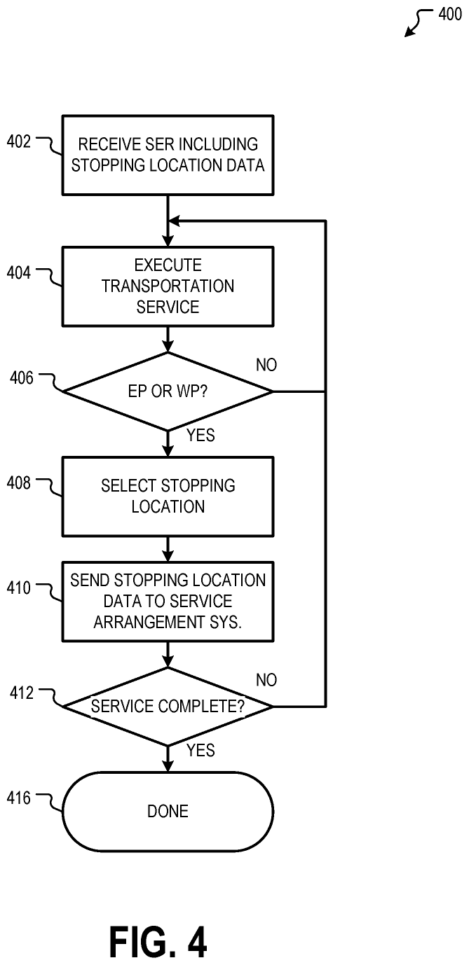

FIG. 4 is a flowchart showing one example of a process flow 400 that may be executed by the SDV 102 upon being selected to execute a transportation service by the service arrangement system 106. At operation 402, the SDV 102 receives a service execution request 119 including stopping location data. The stopping location data describes stopping locations associated with (e.g., near) a service start point, stopping locations associated with a service end point and, if any waypoints are included in the service, stopping locations associated with the waypoints.

At operation 404, the SDV 102 begins to execute the transportation service, for example, by beginning to execute a route to the service start point.

In some examples, the service execution request 119 includes route data describing a route for executing the service and the SDV 102 traverses the received route. In other examples, the SDV 102 deviates from the received route and/or generates its own route. In some examples, the service execution request 119 does not include a route. The SDV 102 may execute the transportation service by traversing a route generated by the SDV 102 and/or by another component.

At operation 406, the SDV 102 determines if it is near a service start point, service end point, or service waypoint. The SDV 102 is near a service start point, end point, or waypoint if it is within a threshold distance of the service start point, end point, or waypoint. If the SDV 102 determines that it is near a service start point, end point, or waypoint, then the SDV 102, at operation 408, selects a stopping location and stops at the stopping location. In some examples, the SDV 102 picks up or drops off payload while stopped at the stopping location.

At operation 410, the SDV 102 sends stopping location data to the service arrangement system 106 (e.g., to the stopping location engine 128 thereof). The stopping location data includes an indication of the stopping location selected at operation 408. Any suitable indication of the stopping location may be used. This includes, for example, geolocation data, such as a vehicle pose, etc. Other example indications of the stopping location can include sensor data collected at or near the stopping location, or any other suitable data.

At operation 412, the SDV 102 determines if the transportation service is complete. For example, if the stopping location was selected for a service end point, the transportation service is complete and the process flow 400 concludes at operation 416. On the other hand, if the stopping location was selected for a service start point and/or waypoint, then the transportation service is not complete. If the transportation service is not complete, the SDV 102 may continue to execute the transportation service at operation 404 as described above.

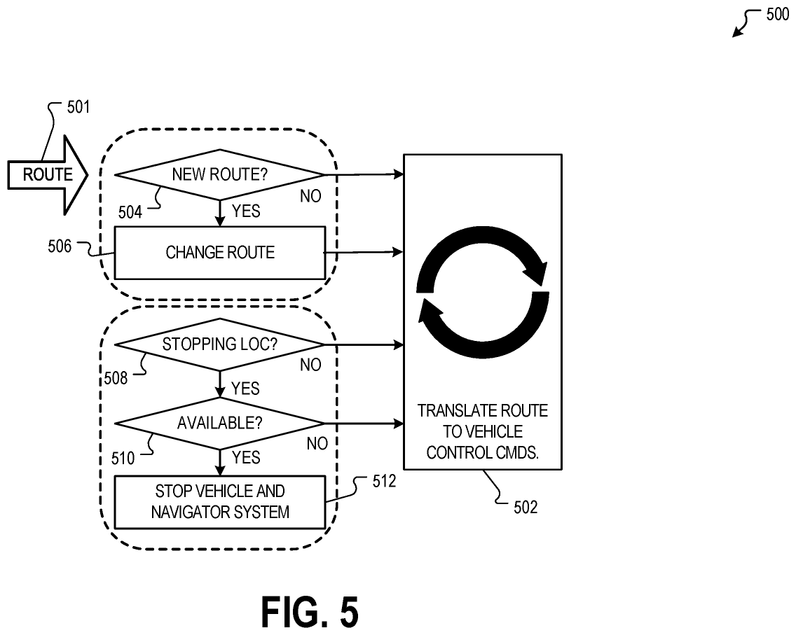

FIG. 5 is a flowchart showing one example of a process flow 500 that can be executed by a vehicle autonomy system of the SDV 102 to implement a route for an SDV. In the process flow 500, route data is provided to a motion planning system of the vehicle autonomy system via one or more route plan messages 501. Route data can describe a route for a transportation service or for a portion of a route for a transportation service (e.g., a portion of a route from the vehicle's current location to a service start point, end point, or waypoint). The route plan messages 501 can include and/or be based on a route generated by any suitable source including, for example, the service arrangement system 106, the vehicle autonomy system itself (e.g., a navigator system thereof), a third party system, etc.

The motion planning system executes a motion planning loop 502. In executing the motion planning loop 502, the motion planning system translates the current route indicated by route data from the route plan messages 501 to commands directed to the vehicle's controls. For example, the motion planning system can generate control commands considering the route data from the route data message 501, map data, and information about other objects in the vehicle's environment, as described herein. The motion plan is translated into commands to the brakes, steering, throttle, and/or other vehicle controls.

Upon receiving the route plan message 501, the motion planning system can, at operation 504, determine if the route plan message 501 includes route data describing a new route (e.g., a route different than the route currently being executed by the motion planning loop 502). If the route plan message 501 describes a new route, the motion planning system, at operation 506, changes the route being implemented by the motion planning loop 502. The motion planning system implements the new route described by the route plan message 501 and resumes generating control commands, for example, according to the new route.

The motion planning loop 502 can also respond when the motion planning system receives an indication that sensor data shows a stopping location, for example, a stopping location indicated by the service execution request 119 provided by the service arrangement system 106. If the motion planning system receives an indication that a stopping location is approaching and that the stopping location is available, then the motion planning system generates control commands to stop the vehicle at the stopping location. For example, at operation 508 the motion planning system determines if sensor data indicates a stopping location. If no stopping location is near, the motion planning system continues to execute the motion planning loop 502.

If sensor data indicates a stopping location at operation 508, the motion planning system, at operation 510, determines whether the stopping location is available. The stopping location is available, for example, if sensor data indicates that there is currently no other vehicle at the stopping location. If the stopping location is not available, the motion planning system continues to execute the motion planning loop 502. If the stopping location is available, the motion planning system, at operation 512, generates commands to stop the vehicle at the available stopping location.

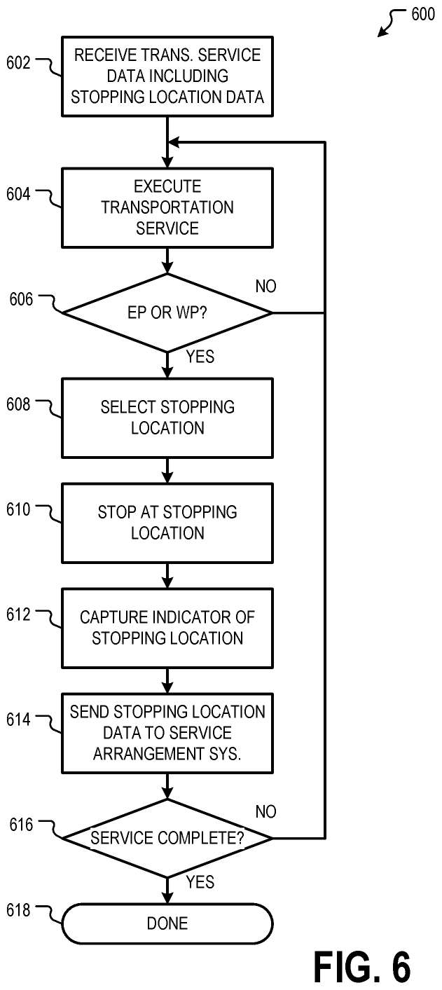

FIG. 6 is a flowchart showing one example of a process flow 600 that may be executed by the SDV 102 upon being selected to execute a transportation service by the service arrangement system 106 in which the SDV 102 captures an indicator of a stopping location. At operation 602, the SDV 102 receives a service execution request 119 including stopping location data. The stopping location data describes stopping locations associated with (e.g., near) a service start point, stopping locations associated with a service end point and, if any waypoints are included in the service, stopping locations associated with the waypoints.

At operation 604, the SDV 102 begins to execute the transportation service, for example, by beginning to execute a route to the service start point. In some examples, the service execution request 119 includes route data describing a route for executing the service and the SDV 102 traverses the received route. In other examples, the SDV 102 deviates from the received route and/or generates its own route. In some examples, the service execution request 119 does not include a route. The SDV 102 may execute the transportation service by traversing a route generated by the SDV 102 and/or by another component.

At operation 606, the SDV 102 determines if it is near a service start point, service end point, or service waypoint. If the SDV 102 determines that it is near a service start point, end point, or waypoint, then the SDV 102, at operation 608, selects a stopping location and stops at the stopping location. In some examples, the SDV 102 picks up or drops off payload while stopped at the stopping location.

At operation 610, the SDV 102 stops at the stopping location, for example, as described herein. At operation 612, the SDV 102 captures an indicator of the stopping location. This can be accomplished in various different ways. For example, the SDV 102 may perform a handshake operation with the parking management device 116 that is present at or near the stopping location. As described herein, the handshake operation causes the SDV 102 to obtain data uniquely identifying the stopping location and/or the parking management device 116. This data can be all or part of stopping location data provided to the service arrangement system 106. In another example, the SDV 102 includes a camera or other suitable image sensor. The camera or other suitable image sensor captures an image of the stopping location. The image may depict a physical indicia of the stopping location such as, for example, an alphanumeric code, a bar code, a QR code, etc.

At operation 614, the SDV 102 sends stopping location data to the service arrangement system 106 (e.g., to the stopping location engine 128 thereof). The stopping location data includes an indication of the stopping location captured at operation 612. At operation 616, the SDV 102 determines if the transportation service is complete. For example, if the stopping location was selected for a service end point, the transportation service is complete and the process flow 600 concludes at operation 618. On the other hand, if the stopping location was selected for a service start point and/or waypoint, then the transportation service is not complete. If the transportation service is not complete, the SDV 102 continues to execute the transportation service at operation 604 as described above.

FIG. 7 is a block diagram 700 showing one example of a software architecture 702 for a computing device. The software architecture 702 may be used in conjunction with various hardware architectures, for example, as described herein. FIG. 7 is merely a non-limiting example of a software architecture 702 and many other architectures may be implemented to facilitate the functionality described herein. A representative hardware layer 704 is illustrated and can represent, for example, any of the above-referenced computing devices. In some examples, the hardware layer 704 may be implemented according to an architecture 800 of FIG. 8 and/or the software architecture 702 of FIG. 7.

The representative hardware layer 704 comprises one or more processing units 706 having associated executable instructions 708. The executable instructions 708 represent the executable instructions of the software architecture 702, including implementation of the methods, modules, components, and so forth of FIGS. 1-6. The hardware layer 704 also includes memory and/or storage modules 710, which also have the executable instructions 708. The hardware layer 704 may also comprise other hardware 712, which represents any other hardware of the hardware layer 704, such as the other hardware illustrated as part of the architecture 800.

In the example architecture of FIG. 7, the software architecture 702 may be conceptualized as a stack of layers where each layer provides particular functionality. For example, the software architecture 702 may include layers such as an operating system 714, libraries 716, frameworks/middleware 718, applications 720, and a presentation layer 744. Operationally, the applications 720 and/or other components within the layers may invoke API calls 724 through the software stack and receive a response, returned values, and so forth illustrated as messages 726 in response to the API calls 724. The layers illustrated are representative in nature and not all software architectures have all layers. For example, some mobile or special-purpose operating systems may not provide a frameworks/middleware 718 layer, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service.

The interrupt service may detect the receipt of a hardware or software interrupt and, in response, cause the software architecture 702 to pause its current processing and execute an ISR when an interrupt is received. The ISR may generate an alert.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), WiFi® drivers, NFC drivers, audio drivers, power management drivers, and so forth depending on the hardware configuration.

The libraries 716 may provide a common infrastructure that may be used by the applications 720 and/or other components and/or layers. The libraries 716 typically provide functionality that allows other software modules to perform tasks in an easier fashion than by interfacing directly with the underlying operating system 714 functionality (e.g., kernel 728, services 730, and/or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) may provide a higher-level common infrastructure that may be used by the applications 720 and/or other software components/modules. For example, the frameworks 718 may provide various graphical user interface (GUI) functions, high-level resource management, high-level location services, and so forth. The frameworks 718 may provide a broad spectrum of other APIs that may be used by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. The third-party applications 742 may include any of the built-in applications 740 as well as a broad assortment of other applications. In a specific example, the third-party application 742 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 742 may invoke the API calls 724 provided by the mobile operating system such as the operating system 714 to facilitate functionality described herein.

The applications 720 may use built-in operating system functions (e.g., kernel 728, services 730, and/or drivers 732), libraries (e.g., system libraries 734, API libraries 736, and other libraries 738), or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with a user.

Some software architectures use virtual machines. For example, systems described herein may be executed using one or more virtual machines executed at one or more server computing machines. In the example of FIG. 7, this is illustrated by a virtual machine 748. A virtual machine creates a software environment where applications/modules can execute as if they were executing on a hardware computing device. The virtual machine 748 is hosted by a host operating system (e.g., the operating system 714) and typically, although not always, has a virtual machine monitor 746, which manages the operation of the virtual machine 748 as well as the interface with the host operating system (e.g., the operating system 714). A software architecture executes within the virtual machine 748, such as an operating system 750, libraries 752, frameworks/middleware 754, applications 756, and/or a presentation layer 758. These layers of software architecture executing within the virtual machine 748 can be the same as corresponding layers previously described or may be different.

FIG. 8 is a block diagram illustrating a computing device hardware architecture 800, within which a set or sequence of instructions can be executed to cause a machine to perform examples of any one of the methodologies discussed herein. The hardware architecture 800 describes a computing device for executing the vehicle autonomy system, described herein.

The architecture 800 may operate as a standalone device or may be connected (e.g., networked) to other machines. In a networked deployment, the architecture 800 may operate in the capacity of either a server or a client machine in server-client network environments, or it may act as a peer machine in peer-to-peer (or distributed) network environments. The architecture 800 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 800 includes a processor unit 802 comprising at least one processor (e.g., a central processing unit (CPU), a graphics processing unit (GPU), or both, processor cores, compute nodes). The architecture 800 may further comprise a main memory 804 and a static memory 806, which communicate with each other via a link 808 (e.g., bus). The architecture 800 can further include a video display unit 810, an input device 812 (e.g., a keyboard), and a UI navigation device 814 (e.g., a mouse). In some examples, the video display unit 810, input device 812, and UI navigation device 814 are incorporated into a touchscreen display. The architecture 800 may additionally include a storage device 816 (e.g., a drive unit), a signal generation device 818 (e.g., a speaker), a network interface device 820, and one or more sensors (not shown), such as a Global Positioning System (GPS) sensor, compass, accelerometer, or other sensor.

In some examples, the processor unit 802 or another suitable hardware component may support a hardware interrupt. In response to a hardware interrupt, the processor unit 802 may pause its processing and execute an ISR, for example, as described herein.

The storage device 816 includes a machine-storage medium 822 on which is stored one or more sets of data structures and instructions 824 (e.g., software) embodying or used by any one or more of the methodologies or functions described herein. The instructions 824 can also reside, completely or at least partially, within the main memory 804, within the static memory 806, and/or within the processor unit 802 during execution thereof by the architecture 800, with the main memory 804, the static memory 806, and the processor unit 802 also constituting machine-readable media.

### Executable Instructions and Machine-Storage Medium

The various memories (i.e., 804, 806, and/or memory of the processor unit(s) 802) and/or storage device 816 may store one or more sets of instructions and data structures (e.g., instructions) 824 embodying or used by any one or more of the methodologies or functions described herein. These instructions, when executed by processor unit(s) 802 cause various operations to implement the disclosed examples.

As used herein, the terms “machine-storage medium,” “device-storage medium,” “computer-storage medium” (referred to collectively as “machine-storage medium 822”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 822 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 822 specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 824 can further be transmitted or received over a communications network 826 using a transmission medium via the network interface device 820 using any one of a number of well-known transfer protocols (e.g., HTTP). Examples of communication networks include a LAN, a WAN, the Internet, mobile telephone networks, plain old telephone service (POTS) networks, and wireless data networks (e.g., Wi-Fi, 3G, 4G LTE/LTE-A, 5G or WiMAX networks). The term “transmission medium” shall be taken to include any intangible medium that is capable of storing, encoding, or carrying instructions for execution by the machine, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as examples can feature a subset of said features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

1. A method of operating a self-driving vehicle, comprising:
selecting, by a service arrangement system, a first self-driving vehicle for providing a first transportation service;
sending, by the service arrangement system to the first self-driving vehicle, first stopping location data describing a first set of stopping locations associated with the first transportation service;
causing, by the service arrangement system, the first self-driving vehicle to begin executing a route associated with the first transportation service;
receiving, by the service arrangement system, stopping location use data indicating that the first self-driving vehicle is stopped at a first stopping location of the first set of stopping locations; and
sending, by the service arrangement system, stopping location payment data to a parking management system, the stopping location payment data indicating a payment for use of the first stopping location by the first self-driving vehicle.

2. The method of claim 1, wherein the stopping location use data is received from the first self-driving vehicle and comprises handshake data exchanged between the first self-driving vehicle and a parking management device positioned at the first stopping location.

3. The method of claim 1, wherein the stopping location use data is received from the first self-driving vehicle and comprises image data describing a stopping location identifier symbol positioned at the first stopping location.

4. The method of claim 1, wherein the stopping location use data is received from a parking management device and comprises an indication of the first self-driving vehicle.

5. The method of claim 1, wherein the stopping location use data comprises position data describing a position of the first self-driving vehicle, the method further comprising determining that the position corresponds to the first stopping location.

6. The method of claim 1, wherein the stopping location use data comprises geolocation data describing a position occupied by the first self-driving vehicle during a time period, the method further comprising:
determining, using the geolocation data, that the position corresponds to the first stopping location; and
determining from the geolocation data a length of time that the first self-driving vehicle was stationary at the position, wherein the stopping location payment data indicates a payment that is based at least in part on the length of time that the first self-driving vehicle was stationary at the position.

7. The method of claim 1, further comprising:
detecting, by the service arrangement system, that the payment for use of the first stopping location by the first self-driving vehicle was unsuccessful; and
causing, by the service arrangement system, the first self-driving vehicle to leave the first stopping location.

8. The method of claim 1, further comprising:
selecting, by the service arrangement system, a second self-driving vehicle for providing a second transportation service;
sending, by the service arrangement system to the second self-driving vehicle, second stopping location data describing a second set of stopping locations associated with the second transportation service;
receiving, by the service arrangement system, second stopping location use data indicating that the second self-driving vehicle is stopped at a second stopping location;
determining, by the service arrangement system and based at least in part on the second stopping location data, that the second stopping location is not part of the second set of stopping locations; and
causing, by the service arrangement system, the second self-driving vehicle to leave the second stopping location.

9. A service arrangement system for self-driving vehicles, comprising:
one or more processors; and
a storage device comprising instructions thereon that, when executed by the one or more processors, causes the one or more processors to perform operations comprising:
selecting a first self-driving vehicle for providing a first transportation service;
sending first stopping location data describing a first set of stopping locations associated with the first transportation service;
causing the first self-driving vehicle to begin executing a route associated with the first transportation service;
receiving stopping location use data indicating that the vehicle is stopped at a first stopping location of the first set of stopping locations; and
sending stopping location payment data to a parking management system, the stopping location payment data indicating a payment for use of the first stopping location by the first self-driving vehicle.

10. The system of claim 9, wherein the stopping location use data is received from the first self-driving vehicle and comprises handshake data exchanged between the first self-driving vehicle and a parking management device positioned at the first stopping location.

11. The system of claim 9, wherein the stopping location use data is received from the first self-driving vehicle and comprises image data describing a stopping location identifier symbol positioned at the first stopping location.

12. The system of claim 9, wherein the stopping location use data is received from a parking management device and comprises an indication of the first self-driving vehicle.

13. The system of claim 9, wherein the stopping location use data comprises geolocation data describing a first position of the first self-driving vehicle, the operations further comprising determining that a first position corresponds to the first stopping location.

14. The system of claim 9, wherein the stopping location use data comprises geolocation data describing a first position of plurality of positions occupied by the first self-driving vehicle during a first time period, the operations further comprising:
determining, using the geolocation data, that the first position corresponds to the first stopping location; and
determining from the geolocation data a length of time that the first self-driving vehicle was stationary at the first position, wherein the stopping location payment data indicates a payment that is based at least in part on the length of time that the first self-driving vehicle was stationary at the first position.

15. The system of claim 9, the operations further comprising:
detecting, by the service arrangement system, that the payment for use of the first stopping location by the first self-driving vehicle was unsuccessful; and
causing, by the service arrangement system, the first self-driving vehicle to leave the first stopping location.

16. The system of claim 9, the operations further comprising:
selecting, by the service arrangement system, a second self-driving vehicle for providing a second transportation service;
sending, by the service arrangement system, second stopping location data describing a second set of stopping locations associated with the second transportation service;
receiving, by the service arrangement system, second stopping location use data indicating that the vehicle is stopped at a second stopping location;
determining, by the service arrangement system and based at least in part on the second stopping location use data, that the second stopping location is not part of the second set of stopping locations; and
causing, by the service arrangement system, the second self-driving vehicle to leave the second stopping location.

17. A non-transitory machine-storage medium comprising instructions thereon that, when executed by one or more processors, cause the one or more processors to perform operations comprising:
selecting a first self-driving vehicle for providing a first transportation service;
sending first stopping location data describing a first set of stopping locations associated with the first transportation service;
causing the first self-driving vehicle to begin executing a route associated with the first transportation service;
receiving stopping location use data indicating that the vehicle is stopped at a first stopping location of the first set of stopping locations; and
sending stopping location payment data to a parking management system, the stopping location payment data indicating a payment for use of the first stopping location by the first self-driving vehicle.

18. The machine storage medium of claim 17, wherein the stopping location use data is received from the first self-driving vehicle and comprises handshake data exchanged between the first self-driving vehicle and a parking management device positioned at the first stopping location.

19. The machine storage medium of claim 17, wherein the stopping location use data is received from the first self-driving vehicle and comprises image data describing a stopping location identifier symbol positioned at the first stopping location.

20. The machine storage medium of claim 17, wherein the stopping location use data is received from a parking management device and comprises an indication of the first self-driving vehicle.
